(19) United States
(12) Patent Application Publication
(10) Pub. No.: US 2004/0168905 A1
(43) Pub. Date: Sep. 2, 2004

(54) Method of generating nitrogen oxides and pertaining system

(76) Inventors: Frank Duvinage, Kirchheim (DE); Christian Goerigk, Korb (DE); Thomas Hammer, Hemhofen (DE); Thomas Kappes, Erlangen (DE); Arno Nolte, Stuttgart (DE); Markus Paule, Korb (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/733,757

(22) Filed: Dec. 12, 2003

(30) Foreign Application Priority Data
Dec. 12, 2002 (DE) 10258185.1

(51) Int. Cl. B01J 19/08; B01J 19/12

(52) U.S. Cl. 204/164; 422/186.04; 422/186.07

(57) ABSTRACT

NOₓ is generated by means of a plasma-enhanced method which, with the addition of H₂-containing gas, reduces NOₓ to NH₃ and uses the thus obtained NH₃ as the reducing agent for an SCR catalyst for exhaust emission control. A plasma reactor is provided in the corresponding apparatus for performing the method.

### CROSS-REFERENCE TO RELATED APPLICATIONS

This application claims the priority of German Patent document 102 58 185.1, filed Dec. 12, 2002, the disclosure of which is expressly incorporated by reference herein.

### FIELD OF THE INVENTION

The invention relates to a method of generating nitrogen oxides by means of a plasma-enhanced process from air, exhaust gas and/or another gas mixture containing oxygen and nitrogen for generating ammonia as a reducing agent for an exhaust emission control operating according to the SCR process (Selective Catalytic Reduction) in the case of an internal-combustion engine in mobile systems, particularly in a motor vehicle. In addition, the invention also relates to the corresponding system for implementing the method, which comprises a plasma reactor.

### BACKGROUND OF THE INVENTION

The catalytic reduction of nitrogen oxides (NOₓ) on board motor vehicles having lean-operated internal-combustion engines requires a reducing agent because of the oxygen-containing exhaust gas. With hydrocarbons as the reducing agent, the catalytic reaction does not take place particularly selectively, so that a large portion of the reducing agent reacts with the oxygen in the exhaust gas without having a reducing effect. In contrast, reducing agents, such as urea, which separate ammonia (NH₃) or NH³, normally require an additional tank or reservoir and a corresponding infrastructure for the supply of the motor vehicles.

In order to be able to do without such an infrastructure, it has been suggested in the to generate NH₃ on board of motor vehicles, for the purpose of which reference is made to German Patent Documents DE 199 03 533 A1, DE 199 22 960 A1 and DE 199 22 961 A1.

In German Patent Document D199 03 533 A1, it is suggested to generate NH₃ by combining a gas discharge plasma and a catalyst in a rich gas flow. Here, according to the invention, the rich gas flow is generated by means of a burner substoichiometrically operated with air, a cylinder of the internal-combustion engine substoichiometrically operated with air or by injecting hydrocarbons into an air flow. However, as tests have demonstrated, the NH₃ formation does not take place sufficiently selectively. A main occurrence is the formation of harmful and toxic by-products, particularly of HCN. Preferably dielectrically hindered discharges are suggested for generating plasma.

In German Patent Document DE 199 22 960 A1, it is suggested that, for generating NH₃, the rich gas flow be guided from cylinders of an internal-combustion engine operated substoichiometrically with air, first through a plasma reactor and then through a catalytic reactor. Neither the used plasma reactor, nor the catalyst are specified in detail. However, also in this case, the formation of by-products, such as HCN, has to be expected.

In German Patent Document DE 19 22 961 A1, it is suggested that NH₃ be generated by the reduction of NO in a rich gas flow and that the NO required for this purpose be generated by means of a separate source which is independent of the internal-combustion engine. Preferably, a hot plasma is to be used for this purpose which, however, is not specified in detail.

All above-mentioned solutions concerning the problem of an exhaust emission control by means of a plasma-based generating of NH₃ on board a motor vehicle do not address existing questions and problems:

The formation of dangerous by-products should be avoided. Otherwise, this type of an exhaust emission control system will not be approved.

The energy demand for generating NH₃ on board the motor vehicle has to be low. Since lean-operated internal-combustion engines are only attractive as long as the fuel consumption and thus the CO₂-emission are clearly below the corresponding values of motor vehicles with stoichiometrically operated internal-combustion engines (Otto-engines with a controlled 3-way catalyst), an energy-efficient generating of NH₃ is extremely important.

The selectivity of the generating of NH₃ has to be high in order to be able to achieve sufficient NH₃-concentrations in the exhaust line.

The plasma reactor and the plasma-catalytic reactor respectively should be compact and simultaneously be designed for a sufficiently long service life in the motor vehicle.

The power supply should be compact, compatible with the operation of the motor vehicle and producible in a cost-effective manner.

### SUMMARY OF THE INVENTION

It is therefore an object of the invention to improve the method of controlling the exhaust emission such that, particularly with respect to the generating of NOₓ, it can be used according to the practical demands. A corresponding system is to be provided particularly for that purpose.

According to the invention, a method is indicated for generating NH₃ on board a motor vehicle, which method is based on, a plasma process for generating NOₓ and meets the requirements for practical use. Such a plasma process is suggested for generating NOₓ from air, exhaust gas or another gas mixture containing oxygen and nitrogen as the fuel gas which has the following characteristics:

The mass flow of the fuel gas is low compared to the mass flow of the exhaust gas of the internal-combustion engine.

As a result of the gas discharge, the fuel gas is heated to temperatures of above 2,000 K, preferably above 2,800 K.

Molecular nitrogen and oxygen are electronically excited by non-thermal plasma-induced impact processes with high-energy electrons, are dissociated and ionized.

As a result of reactions of the electronically excited molecules, molecule fractions and ions with the fuel gas heated by the plasma, nitrogen oxides are formed, but preferably, because of the high temperature, NO is formed. As a result of the gas temperature and the formation rates of excited molecules and molecule fractions, the reaction times are maintained in the range of from below 1 μs to 10 ms.

The NO formed in the hot fuel gas is chemically stabilized by a rapid cooling at a rate of typically 100,000 K/s, however, at least 10,000 K/s, to temperatures below 1,500 K, preferably below 1,000 K.

The NOₓ-concentration generated by the gas discharge plasma is large in comparison to the NOₓ-concentration in the exhaust gas. The NO is preferably generated with the maximal, thermodynamically possible concentration of approximately 5%. A typical range is at 2% to 5%.

In the case of a system according to the invention, these characteristics are achieved particularly in that

a gas discharge plasma is operated in the plasma reactor which fluctuates considerably with respect to space and/or time,

the plasma has a specific energy density, that is, a ratio of the plasma rate to the gas volume flow, of 1 kJ/m³ to 50 kJ/m³, preferably 2 kJ/m³ to 10 kJ/m³, and

the fuel gas flowing into the plasma zone at a rate of from 10 m/s to 50 m/s is accelerated to rates of from 100 m/s to 500 m/s.

Further details and advantages of the invention are found in the following description of embodiments by means of a drawing in conjunction with the claims.

### BRIEF DESCRIPTION OF THE FIGURES

FIG. 1 is a graphic representation with thermodynamic equilibrium concentrations, on the one hand, and the thermal NO formation time in air, on the other hand, each as a function of the temperature;

FIG. 2 is a block diagram of an exhaust emission control system with devices for generating NH₃; and

FIGS. 3 to 10 are views of different alternatives for the construction of the NO reactor in FIG. 2.

In the figures, identical elements have the same reference numbers. The figures are partially described jointly.

### DETAILED DESCRIPTION OF THE EMBODIMENTS

Examples of gas discharges with the above-mentioned characteristics are so-called rotarcs (rotating arcs) and glidarcs (gliding arcs), as long as they are operated at sufficiently low electric currents of below 1 À. In this case, because of the transient character of the gas discharge, with typically 1,200 V with electrode spacings of several millimeters, significantly higher median burn field intensities occur than in the case of stabilized thermal arc plasmas.

Here, rotationally symmetrical reactor geometries are suggested with a pin electrode as the high-voltage electrode which is surrounded by the flow of entering gas and is inserted in an electrically insulated manner, and with a grounded counter electrode provided with a centric hole, through which the gas can exit from the plasma zone formed by the two electrodes into the back space of the hole electrode. The gas inflow takes place in a uniformly distributed manner along the circumference in the back space of the pin electrode; the gas outlet is situated in the back space of the hole electrode. The geometry of this reactor is designed such that the gas discharge ignites between the pin electrode and the inlet opening of the hole electrode. As a result of the gas flow in the area of the hole electrode, the starting point of the gas discharge is very rapidly carried from the inlet opening of the hole electrode into the hole electrode and is partially carried into its back space. In this case, the voltage dropping at the gas discharge will rise to the value which the electric power unit can just barely still supply. The gas discharge then ceases and fires again in the area of the inlet opening. Typically, this process is repeated at frequencies of from 100 Hz to 10 kHz. As a result of this process, excessively high currents are avoided which reduce the service life of the electrode. In addition, by way of the median voltage drop, which is high in comparison to the thermal arc, it is ensured that non-thermal plasma effects take place, such as an electron impact dissociation of molecular oxygen.

The fluctuating character of the gas discharge as well as the stabilization of the voltage drop at a high value are therefore caused by the gas flow and thereby also by the geometry of the gas discharge reactor. Specifically, the median voltage drop can also be controlled by the gas flow. In a simple form, a fast axial flow of the fed gas can be utilized for this purpose, which axial flow is still accelerated in the gas discharge zone and may thus assume values of up to several 100 m/s. A further increase of the mass flow occurs when the fuel gas is caused to flow tangentially into the reactor.

In addition to the above-mentioned gas flow into the reactor, the shaping-out of the hole electrode and measures in the back space of this hole electrode as a result of gas-dynamic effects determine the reaction time at a high temperature and the cooling rate. In this case, the transient character of the gas discharge and the fast gas flow play an important role. On the other hand, in the outflow of the gas discharge in and behind the hole electrode, an intensive wall contact of the product gas may be provided which significantly accelerates the cooling. Typical distances from the plasma zone to the wall are situated in the flow direction of the gas at 1 to 5 cm. Another possibility is the causing of a turbulent mixing with already cooled gas in the back space of the hole electrode, which gas recirculates as a result of the flow. This effect characterized by backflow zones may be promoted by the tangential gas flow into the reactor. Additional possibilities for promoting this effect consist of the use of baffle plates or small recirculation tubes. In order to facilitate a reaching of the gas temperature of above 2,800 K, the fuel gas can be preheated. In a preferred variant, the fuel gas is preheated by the exhaust gas of the internal-combustion engine or that of the plasma reactor itself. In the latter case, the heating of the fuel gas flowing into the plasma reactor can advantageously be combined with the cooling of the product gas flow by means of a heat exchanger.

Finally, for the reaching of a high gas temperature in the plasma as well as for the subsequent cooling, it may be advantageous to divide the gas flow and to guide only a portion of the gas through the plasma zone but to introduce the other portion as a quench gas into the reactor back space for a fast cooling. In this case, a fast mixing occurs when the flow is directed frontally at the hot gas flowing out of the hole electrode. Another mixing possibility consists of the radial or tangential introduction of the cold gas flow into the plasma gas flow in an area between the inlet side and the outlet side of the hole electrode.

Such plasmas can be operated by means of a direct voltage as well as by means of an alternating voltage. The frequency of the alternating voltage may be between 50 Hz and 1 MHz. It was found that although, during the operation by means of an alternating voltage, at a low frequency, the gas discharge is extinguished in the zero crossings of the voltage, it fires again without any problem as a result of the residual charge carriers. As the frequency rises, the firing of the gas discharge is facilitated, so that the (re-) firing voltage decreases with a rising frequency.

Independently of the form of the electric excitation (direct voltage or alternating voltage), a significantly higher voltage is required for the first firing, which voltage can be provided by a

transient increase of the voltage or alternating-voltage amplitude supplied by the power unit

or a separately generated firing pulse.

The firing pulse can either be transported to the high-voltage electrode of the plasma reactor, shielded by way of a network of inductive resistors, capacitors, ohmic resistors and diodes from the actual power unit, or can be used for the firing by means of a separate auxiliary electrode. In a preferred variant, the firing pulse is generated in the high-voltage power unit itself. Depending on the variant, voltages of typically 6 kV (directly to the high-voltage electrode; range 2 kV to 20 kV) or less (approximately 1 kV when an auxiliary electrode is used) are required for the firing pulse. In order to ensure a reliable firing, a minimum energy is required for the firing pulse which is typically in the range of 1-100 mJ, preferably at 20 mJ.

In an embodiment, a sufficiently high impedance of from 1 kΩ to 10 kΩ of the power unit at frequencies in the kHz-range is important for the continuous operation in order to avoid the transition of the gas discharge into a stationary thermal arc which is initiated by a rapid rise of the gas discharge current. This can be achieved by using a choke with an inductance of several Henry with which an ohmic resistor is connected in series. The latter has the function of limiting the maximal current independently of the current rise time.

The NH₃ is generated by means of a catalytic reduction from the NO, which is generated in a high concentration. For this purpose, the reducing agent consisting of a hydrocarbon-containing or H₂-containing gas is either added directly into the excess, so that the residual oxygen from the generating of NO is consumed by catalytic combustion and the NO is reduced to NH₃; or, in a first step, the residual oxygen can be removed from the NO-containing gas flow and then the NO can be reduced to NH₃.

Because of the operating conditions of the plasma reactor, NO-concentrations of from 1 to 6% can be reached. This is by orders of magnitude above the values which occur in the exhaust gas of an internal-combustion engine, for example, of a diesel passenger car (currently 200 ppm). As a result, NO can be generated in the secondary flow and, as a result of the addition of fuel and H₂/CO-mixtures to the product gas of the NO-generator, NH₃ can be catalytically generated while the additional fuel consumption for generating the reducing agent (RM) does not counteract the consumption advantage of the diesel engine in comparison to the Otto engine.

By using temperatures around 2,800 K, not only nitrogen radicals but also oxygen radicals are utilized for generating NO because the reaction

O+N₂→NO+N (1)

has a rate coefficient which rises considerably as the temperature increases. Subsequently, additional reactions take place which, at sufficiently high temperatures of above 2,800 K, rapidly lead the NO-concentration toward the thermodynamic equilibrium value:

N+O₂→NO+O (2)

NO+N→N₂+O (3)

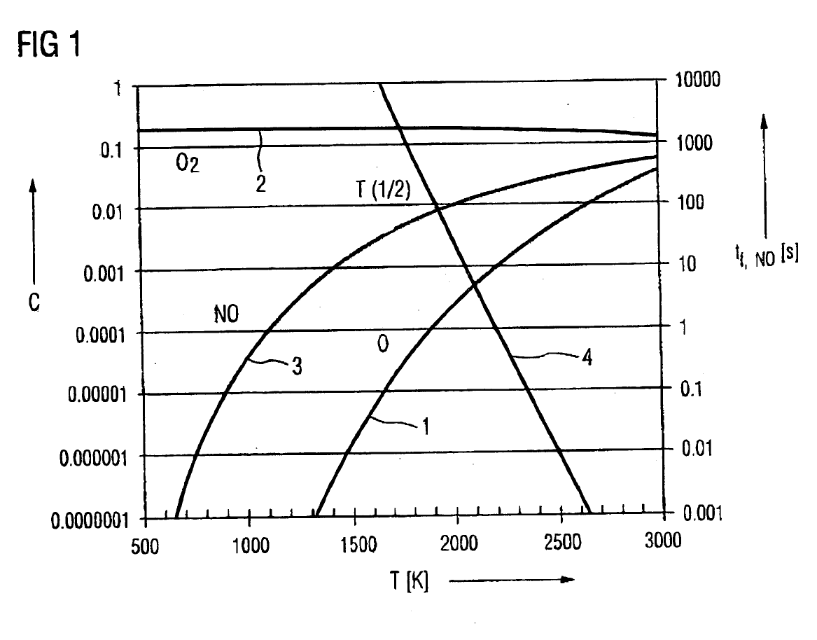

In this case, the rate coefficient of the reaction (2) also rises considerably with the temperature, while that for reaction (3) is only slightly dependent on the temperature. At temperatures below 2,800 K, the thermal NO-formation is a slow process (see graph 4 for the formation time T(1/2) in FIG. 1 below), so that the thermodynamic equilibrium values (NO) cannot be reached within a short time for these temperatures.

In FIG. 1, the temperature is logarithmically indicated in kelvin on the abscissa; the equilibrium concentration is logarithmically indicated on the left ordinate, and the thermal NO-formation time is logarithmically indicated on the right ordinate. Number 1 marks the graph for an oxygen atom; number 2 marks the graph for an oxygen (O₂) molecule; and number 3 marks the graph for NO. It is demonstrated that the oxygen (O₂)-concentration is largely constant over the temperature, while the O-atom concentration and the NO-concentration rise steeply with the temperature and, at approximately 3,000 K, run into a saturation. Correspondingly, the NO-formation time decreases with the temperature inversely proportionally from high values, for example, 10⁴ S at 1,500 K, to low values, for example, 10^{31 3} at 2,600 K.

As a result of the non-thermal plasma-induced impact processes, a significant acceleration of the NO-formation occurs, however, because the radicals (O) initiating the reactions (1) to (3) are now provided by a non-thermal process and thus with concentrations clearly above the thermal equilibrium value.

In comparison to arcs, as a result of the increased voltage drop and the reduced current, the thermal loading of the electrodes is minimized. The transient character of the gas discharge also contributes to this fact which can be achieved by the fast running of the cathode base in the gas flow. The gas flow connected with a small plasma volume also provides a fast cooling and stabilization of the NO-concentration at a high value: During a slow cooling, a portion of the formed NO would be reduced again as a result of reaction (3).

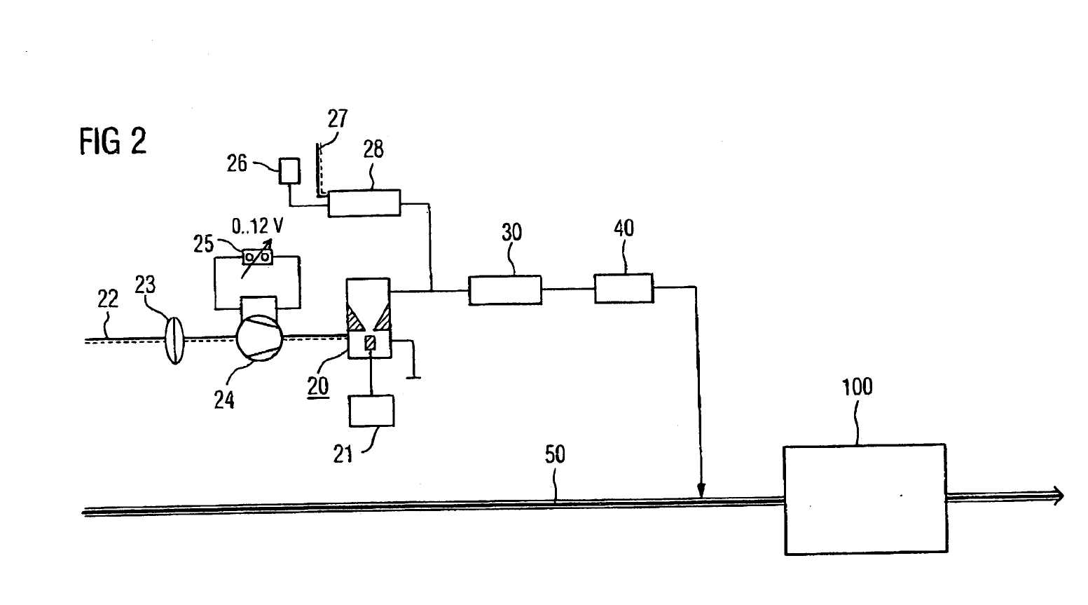

FIG. 2 illustrates a system diagram for the exhaust emission control with the generating of NO and NH₃. A plasma reactor 20 is connected to a catalyst 30 for the O₂-reduction and a catalyst 40 for the reduction of NO to NH₃. These units are connected to the exhaust line 50 of an internal-combustion engine which is not shown, a SCR (Selective Catalytic Reduction) reactor 100 being provided as an essential element for the exhaust emission control. The latter reactor is conventional, reference being made to International Patent Document WO 99/56 858 A in this regard.

In FIG. 2, air is guided in a pipe 22 by way of a filter 23 to a compressor 24, the compressor 24 being operated by a voltage source 25. The compressed air is fed to a plasma reactor 20 in which NOx is generated. A power unit 21 for high voltages is assigned to the plasma reactor 20. Parallel thereto, synthesis gas is generated in a catalytic syntheses gas generator 28 while fuel 26 and air 27 are fed, which synthesis gas is then fed to the NOx-containing gas.

The gas mixture is fed to a catalyst for the reduction of the residual oxygen, while CO₂ and H₂O are formed, and subsequently is fed to the reduction catalyst for generating the NH₃.

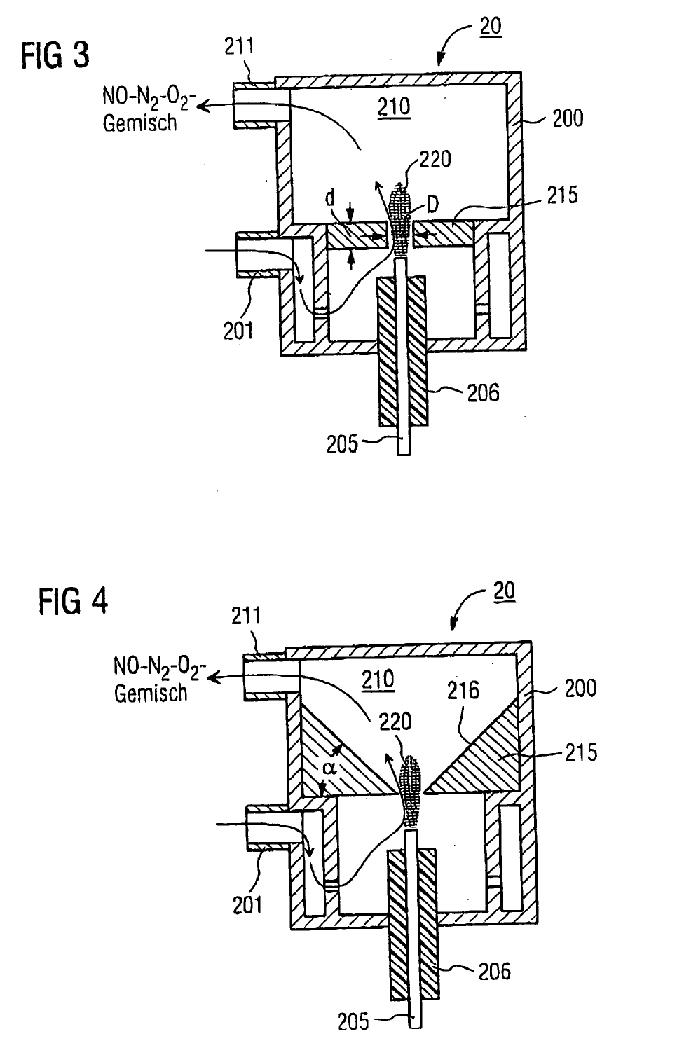

FIGS. 3 to 10 show different alternatives of the electrode geometry in the NO-reactor 20 of FIG. 2. Specifically FIG. 3 shows a complete housing 200 with a gas inlet 201 for air or exhaust gas. The gas flows along a pin electrode 205 acted upon by high voltage and is guided through an electrode back space 210 for the cooling. A hole electrode 215 is present as the ground. A plasma zone 220 is obtained from which an NO—N₂—O₂ mixture is guided out by way of a gas outlet 211.

A corresponding situation is shown in FIGS. 4 to 10, in which case particularly the spatial shaping-out of the ground electrode 215 varies and further modifications are carried out.

In FIG. 3, the NO-reactor 20 with the housing 200 contains a simple planar hole electrode 215. In the central opening 216 of the hole electrode 215, the plasma is ignited so that the above-mentioned plasma zone 220 is formed. Possibilities for influencing the optimization of the plasma exist as a result of the variation of the hole diameter D, of the thickness of the hole electrode d and the distance between the pin electrode 205 and the inlet opening of the hole electrode 215. Particularly the thickness d of the hole electrode 215 defines the length of the plasma duct.

FIG. 4 shows an NO-reactor 20 with a conical electrode back space 210. Concretely, this means that the ground electrode 215 is not planar but has a funnel-shaped construction around the plasma duct, in which case the angle of the cone in the electrode back space or the angle in the electrode funnel is essential. The plasma zone 220 can be defined by the variation of the hole diameter D, the cone angle α and the distance between the pin electrode 205 and the hole electrode 215.

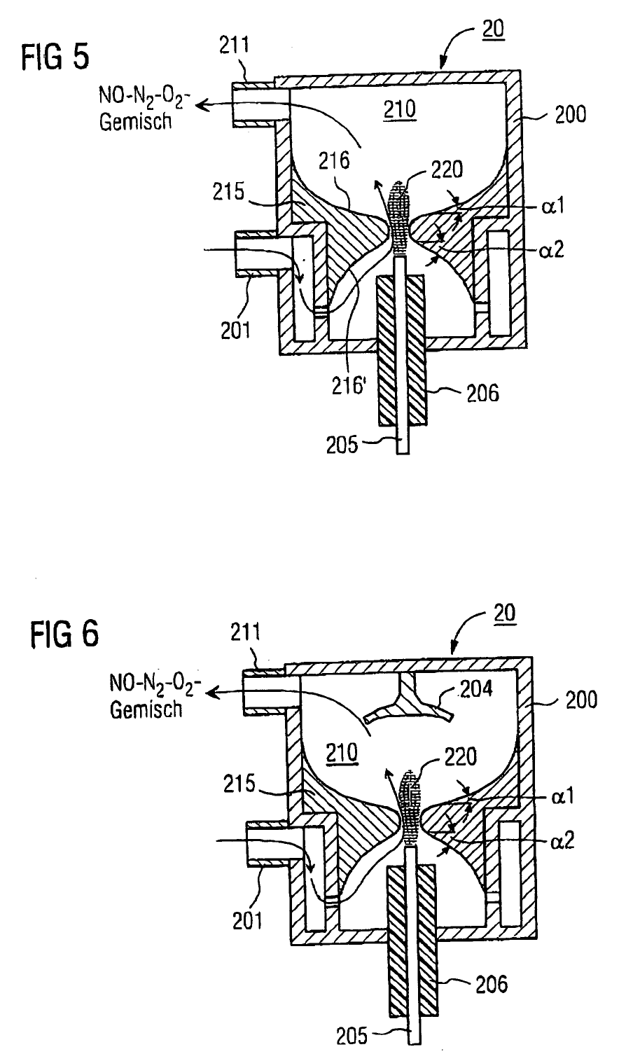

In FIG. 5, in the case of the NO-reactor 20, the hole electrode 215 is fluidically improved, specifically such that both planar surfaces from FIG. 3 are constructed with a profile. This results in a nozzle-type shape of the hole electrode 215, in which case the minimal diameter of the passage opening and the length of the surrounding area with a small diameter can be adapted to the demand. The specific result are therefore two angles of slope α1 and α2 and a length L1 of an area with a diameter in the defined range.

In FIG. 6, the NO-reactor with the fluidically improved hole electrode is additionally provided with a baffle plate 204 in the electrode back space 210. As a result of the baffle plate 204, a forcing of the gas cooling and a recirculation are obtained which can specifically be influenced by the profile of the baffle plate. Specific optimization possibilities are obtained by the variation of the spacing, electrode outlet—baffle plate and the diameter or the shape of the baffle plate 204.

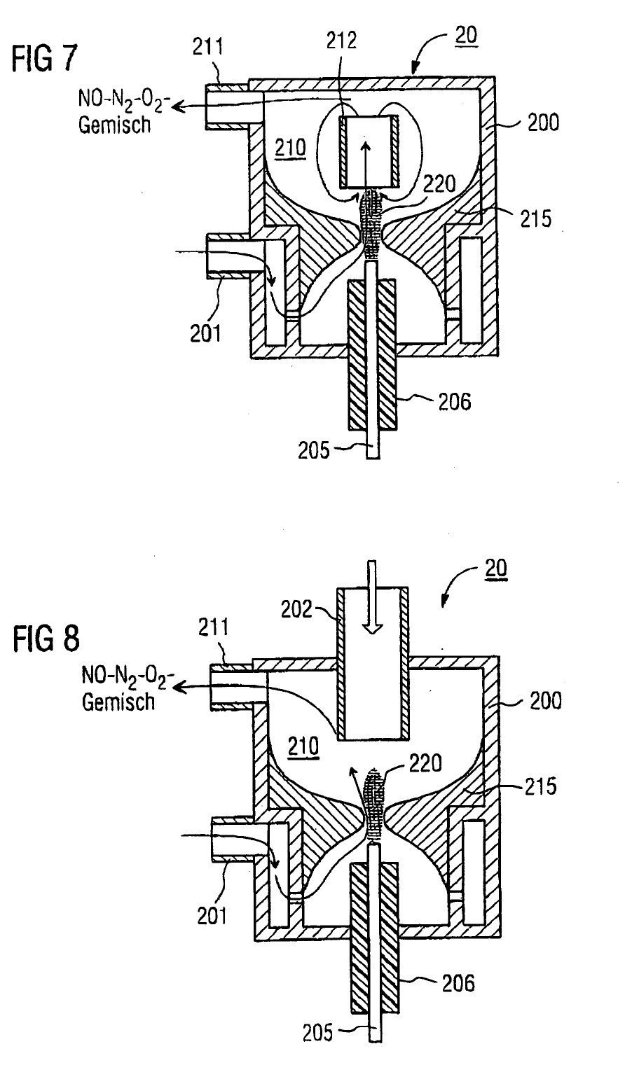

FIG. 7 is based on an NO-reactor 20 corresponding to FIG. 5. In addition to the fluidically improved hole electrode 215, a small circulation tube 212 is provided here for forcing the gas cooling and the recirculation. Specifically, the distance between the electrode outlet and the small recirculation tube as well as its length and its diameter can be varied, so that additional optimization possibilities are created.

Based on the NO-reactor 20 according to FIG. 5, FIG. 8 contains an inlet 202 for the admitting of a quench gas in the housing 200 to the electrode back space 210. By way of the quench gas inlet 202, a suitable quench gas, such as dry air, can be admitted to the back space, whereby the gas cooling and the recirculation are intensified. Optimization possibilities exist by varying the distance between the quench gas inlet and the electrode outlet as well as the ratio of the plasma gas flow to the quench gas flow.

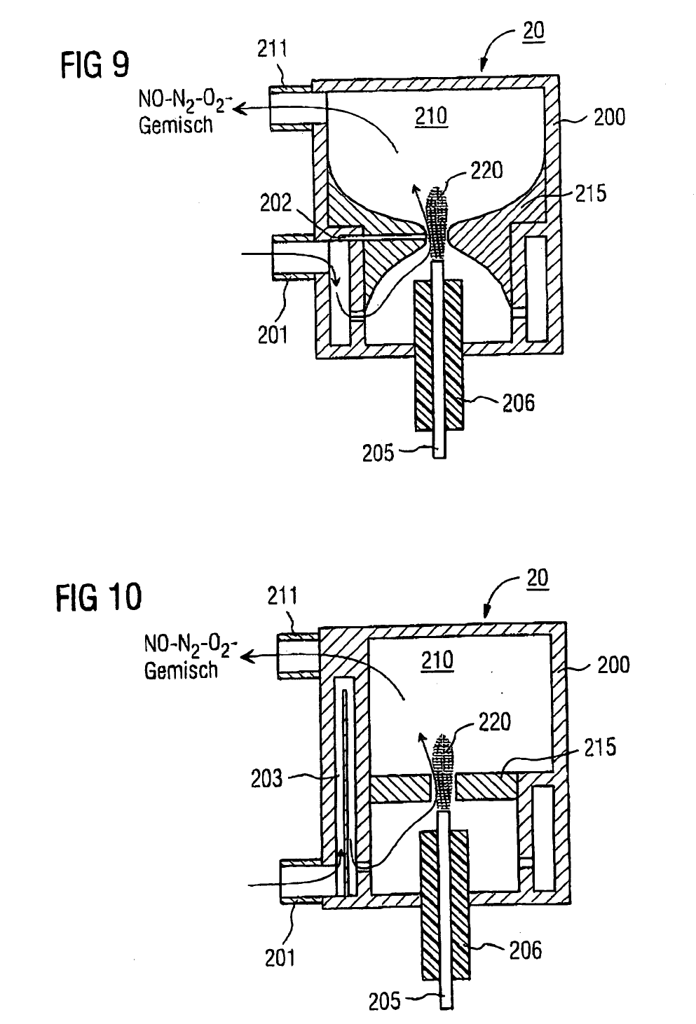

In FIG. 9, the quench gas inlet is provided directly in the fluidically improved hole electrode 215 corresponding to FIG. 5. By admitting the quench gas directly in the area of plasma, further marginal conditions can be adjusted, which is also used for the forcing of the gas cooling and the recirculation. An optimization possibility exists by varying the ratio of the plasma gas flow to the quench gas flow by way of flow cross-sections.

Another possibility is a preheating of the entering gas before the actual plasma reaction. Corresponding to FIG. 10, a bypass pipe 203 is provided in the NO-reactor 20 and leads through the area of the hot product gas. As a result, a preheating of the fuel gas is achieved by the heat exchange with the product gas.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A plasma-enhanced method of generating nitrogen oxides from air, exhaust gas, a combination thereof, or another gas mixture containing oxygen and nitrogen for generating ammonia as a reducing agent for an exhaust emission control operating according to a Selective Catalytic Reduction process in an internal-combustion engine in a mobile system, comprising:
heating a fuel gas in a gas discharge to a temperature above 2,000 K, wherein a mass flow of the fuel gas is low compared to a mass flow of an exhaust gas of the internal-combustion engine;
exciting molecular nitrogen and oxygen by non-thermal plasma-induced impact processes with high energy electrons to cause electronic excitation, dissociation, ionization, or a combination thereof to produce electronically excited molecules, molecule fragments, ions, or a combination thereof; and,
forming one or more oxides of nitrogen by reaction of the electronically excited molecules, molecule fragments, and ions, or combination thereof, wherein a concentration of the one or more nitrogen oxides generated by the gas discharge plasma is from about 2% to about 5%

2. The method of claim 1, wherein the mobile system is a motor vehicle.

3. The method of claim 1, wherein the fuel gas is heated in the gas discharge to a temperature above 2,800 K.

4. The method of claim 1, wherein reaction times of formation processes for forming the nitrogen oxides are maintained from about 1 μs to about 10 ms based on the gas temperature, rates of formation of the excited molecules and molecule fragments, or a combination thereof.

5. The method of claim 1, wherein the NO formed in the hot fuel gas is chemically stabilized by a rapid cooling at a rate of from about 10,000 K/s to about 100,000 K/s, to a temperatures below about 1,500 K.

6. The method of claim 5, wherein the hot fuel gas is cooled to a temperature below about 1,000 K.

7. The method of claim 1, wherein the gas discharge plasma fluctuates with respect to space, time, or a combination thereof.

8. The method of claim 7, wherein the specific energy density of the gas discharge plasma is from about 1 kJ/m³ to about 50 kJ/m³ in the gas discharge volume.

9. The method of claim 8, wherein the specific energy density of the gas discharge plasma is from about 2 kJ/m³ to about 10 kJ/m³ in the gas discharge volume.

10. The method of claim 8, wherein a flow rate of the fuel gas flowing into the gas discharge plasma is from about 10 m/s to about 50 m/s, and a flow rate after acceleration is from about 100 m/s to about 500 m/s.

11. The method of claim 1, wherein rotating arcs are used for generating the gas discharges.

12. The method according of claim 1, wherein gliding arcs are used for generating the gas discharges.

13. A system for plasma-enhanced generation of nitrogen oxides from air, exhaust gas, a combination thereof, or another gas mixture containing oxygen and nitrogen for generation of ammonia as a reducing agent for an exhaust emission control operating in a Selective Catalytic Reduction process in an internal-combustion engine in a mobile system, comprising:
a plasma reactor having an inlet for a fuel gas and an outlet for a process gas;
an electrically insulated pin electrode as a high-voltage electrode disposed in the plasma reactor;
a grounded counter electrode having a centric hole of a first diameter disposed in the plasma reactor; and
a plasma zone situated between the electrodes.

14. The system of claim 13, further comprising a back space in the plasma reactor behind said hole electrode for cooling the discharge plasma.

15. The system of claim 14, wherein gas can exit into the back space of said hole electrode from the plasma zone formed between the two electrodes.

16. The system of claim 15, wherein the gas outlet is situated in the back space of said hole electrode.

17. The system of claim 13, wherein said hole electrode has a planar construction and wherein the first hole diameter and thickness of said hole electrode are variable.

18. The system of claim 13, wherein said hole electrode has a profile at least toward the back space, the thickness of said hole electrode being defined by the slope of the profile.

19. The system of claim 13, wherein said hole electrode has a nozzle-type shape.

20. The system of claim 13, further comprising a baffle plate arranged in the back space of said hole electrode.

21. The system of claim 13, further comprising a recirculation tube provided in the back space of said hole electrode.

22. The system of claim 13, wherein the plasma reactor further comprises an inlet for a quench gas.

23. The system of claim 13, wherein the inlet for the quench gas is arranged in the back space of said hole electrode.

24. The system of claim 13, wherein the inlet for the quench gas is arranged radially in said hole electrode.

25. The system of claim 13, further comprising devices for preheating the fuel gas disposed in the plasma reactor.

26. The system according to claim 25, wherein the devices heat exchangers that exchange heat with a product gas.

27. The system of claim 13, wherein the plasma reactor is configured to produce a gas discharge plasma that fluctuates with respect to space, time, or a combination thereof.

28. The system of claim 13, wherein the plasma reactor further comprises a high voltage direct-voltage source, pulse voltage source, or alternating-voltage source for generating the plasma.

29. The system according to claim 28, wherein a frequency of a pulse direct voltage or a frequency of an alternating voltage is from about 50 Hz to about 1 MHz.

30. (New) The system according to claim 29, wherein an impedance of the voltage source at said frequency is from about 1 kΩ to 10 kΩ.
